(19) United States
(12) Patent Application Publication
(10) Pub. No.: US 2024/0311126 A1
(43) Pub. Date: Sep. 19, 2024

(54) SOFTWARE UPDATING DEVICE, SOFTWARE UPDATING METHOD, NON-TRANSITORY STORAGE MEDIUM, AND SOFTWARE UPDATING SYSTEM

(71) Applicant: TOYOTA JIDOSHA KABUSHIKI KAISHA, Toyota-shi (JP)

(72) Inventors: Tomoaki MIYAZAWA, Nagoya-shi (JP); Ryota NAKABAYASHI, Nagoya-shi (JP); Naoki YOMODA, Toyota-shi (JP); Atsushi MORI, Miyoshi-shi (JP); Hiroshi INOUE, Nagoya-shi (JP); Tsukasa KITAZAWA, Toyota-shi (JP)

(73) Assignee: TOYOTA JIDOSHA KABUSHIKI KAISHA, Toyota-shi (JP)

(21) Appl. No.: 18/428,851

(22) Filed: Jan. 31, 2024

(30) Foreign Application Priority Data
Mar. 13, 2023 (JP) 2023-038709

(51) Int. Cl. G06F 8/65

(52) U.S. Cl. CPC G06F 8/65

(57) ABSTRACT

A software updating device includes a central processing unit (CPU), the CPU being configured to execute: obtaining schedule information, the schedule information including information regarding whether a scheduled event is scheduled for a user and information regarding a time slot of the scheduled event; predicting a blank period in the future in which the scheduled event will not occur, based on the schedule information that is acquired; deciding a scheduled update date-and-time that is a date and time when an update of software for an information processing device is performed, within the blank period; and performing the update of the software at the scheduled update date-and-time.

### CROSS-REFERENCE TO RELATED APPLICATION

This application claims priority to Japanese Patent Application No. 2023-038709 filed on Mar. 13, 2023, incorporated herein by reference in its entirety.

### BACKGROUND

### 1. Technical Field

The disclosure relates to a software updating device, a software updating method, a non-transitory storage medium, and a software updating system.

### 2. Description of Related Art

A control system disclosed in Japanese Unexamined Patent Application Publication No. 2011-158186 (JP 2011-158186 A) includes a personal terminal, a plurality of pieces of equipment, and a control device. The control device acquires operation patterns of the equipment at various timings. Here, operation patterns indicate combinations of operation states of multiple pieces of equipment, such as an operation state of first equipment such as turning on and off and so forth, an operation state of second equipment such as turning on and off and so forth, and so on, for example. The control device then stores a plurality of operation patterns acquired at various timings. The control device also acquires schedule information of a user, from the personal terminal of the user. Here, the schedule information includes information regarding whether a scheduled event is scheduled for the user, and a time slot for the scheduled event. Furthermore, the control device decides, for each scheduled event included in the schedule information, an operation pattern for operating the equipment during the time slot for the scheduled event. At this time, the control device decides an operation pattern for operating the equipment in the time slot for the scheduled event, by having the user select an operation pattern from among the operation patterns stored by the control device. The control device then operates the pieces of equipment according to the decided operation pattern during the time slot for the scheduled event.

### SUMMARY

In a control system such as disclosed in JP 2011-158186 A, there are cases in which updating of software of each piece of equipment is desired, for example. Generally, during while updating software, part or all of functions of each piece of equipment become unusable. Accordingly, when updating of the software is executed indiscriminately, the timings for updating the software may clash with the timings at which the user wants to use each piece of equipment or the timings at which each piece of equipment should operate. In this case, the user has to wait until the updating of the software is completed before using each piece of equipment, which is inconvenient.

A software updating device according to a first aspect of the present disclosure includes a CPU configured to execute: obtaining schedule information, the schedule information including information regarding whether a scheduled event is scheduled for a user and information regarding a time slot of the scheduled event; predicting a blank period in the future in which the scheduled event will not occur, based on the schedule information that is acquired; deciding a scheduled update date-and-time that is a date and time when an update of software for an information processing device is performed, within the blank period; and performing the update of the software at the scheduled update date-and-time.

A software updating method according to a second aspect of the present disclosure is executed by an updating device. The software updating method includes obtaining schedule information, the schedule information including information regarding whether a scheduled event is scheduled for a user and information regarding a time slot of the scheduled event; predicting a blank period in the future in which the scheduled event will not occur, based on the schedule information that is acquired; deciding a scheduled update date-and-time that is a date and time when an update of software for an information processing device is performed, within the blank period; and performing the update of the software at the scheduled update date-and-time.

A non-transitory storage medium according to a third aspect of the present disclosure stores instructions executable by an updating device that cause the updating device to execute the software updating method according to the second aspect described above.

A software updating system according to a fourth aspect of the present disclosure includes a schedule management device that stores schedule information, the schedule information including information regarding whether a scheduled event is scheduled for a user and information regarding a time slot of the scheduled event; and an updating device that is configured to communicate with the schedule management device, and that is installed in a vehicle. The updating device is configured to execute acquiring the schedule information from the schedule management device, predicting a blank period in the future in which the scheduled event will not occur, based on the schedule information that is acquired, deciding a scheduled update date-and-time that is a date and time when an update of software for an information processing device installed in the vehicle is performed, within the blank period, transmitting information regarding the scheduled update date-and-time to the schedule management device when the scheduled update date-and-time is decided, and performing the update of the software at the scheduled update date-and-time. The schedule management device is configured to execute acquiring information regarding the scheduled update date-and-time from the updating device, and updating the schedule information in accordance with information regarding the scheduled update date-and-time.

According to the above configuration, the scheduled update date-and-time is decided to be in a blank period when a scheduled event is unlikely to occur for the user, and accordingly software updating can be suppressed from being performed at a time that is inconvenient for the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an updating system; and

FIG. 2 is a sequence diagram showing first control, second control, and third control.

### DETAILED DESCRIPTION OF EMBODIMENTS

### Schematic Configuration of Updating System

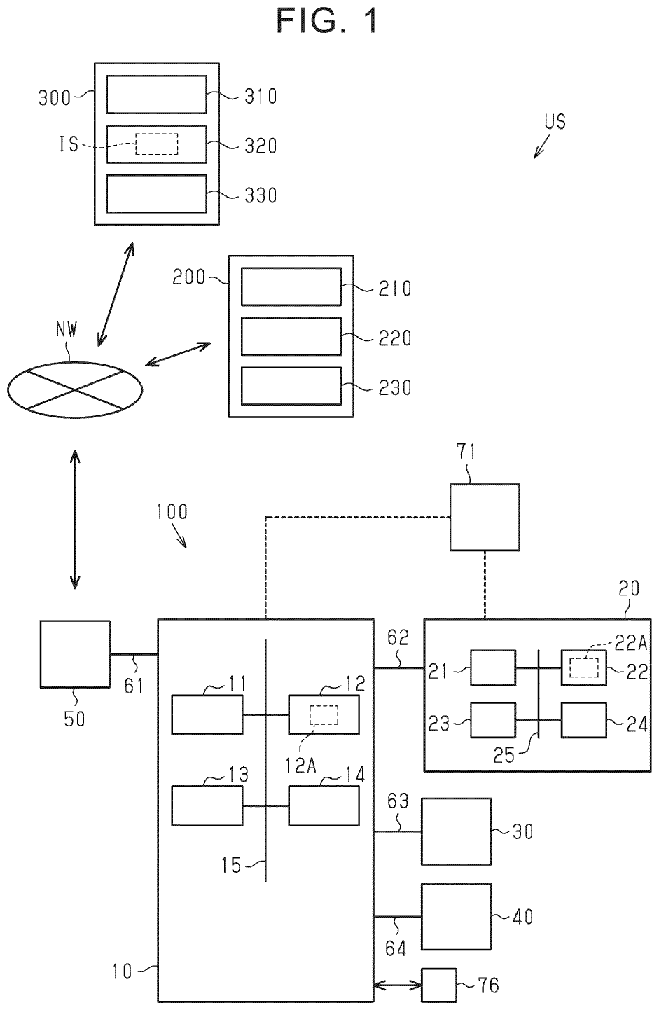

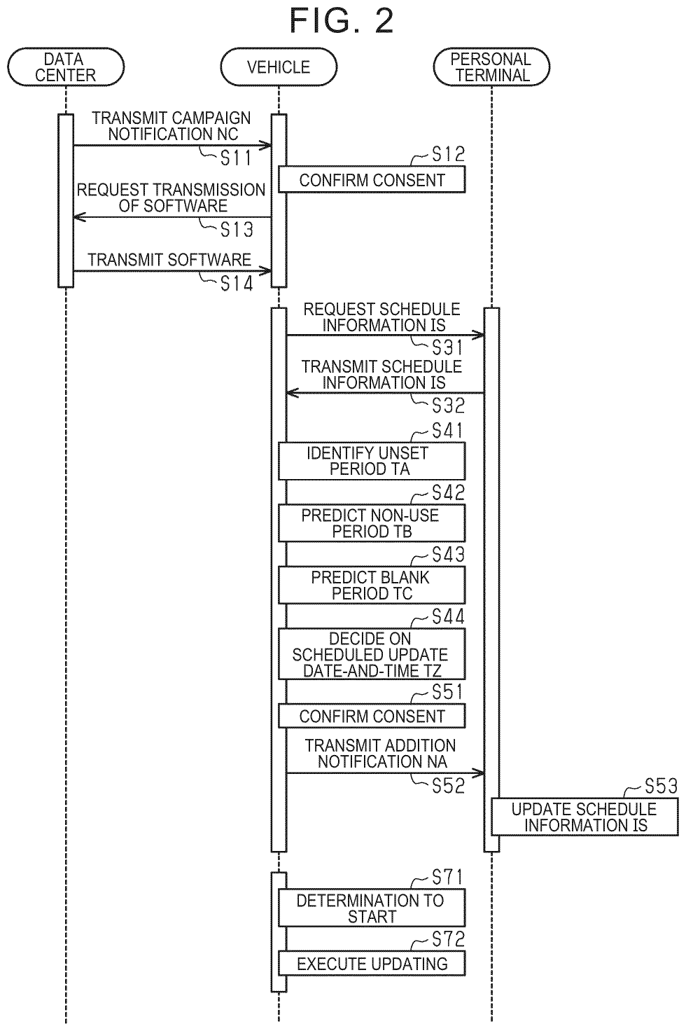

An embodiment of the disclosure will be described below with reference to FIGS. 1 and 2. First, a schematic configuration of an updating system US will be described.

The updating system US illustrated in FIG. 1 includes a plurality of vehicles 100. The vehicles 100 are, for example, automobiles owned by users. Note that in FIG. 1, just one vehicle 100 is illustrated representatively.

The vehicle 100 includes a central ECU 10, a powertrain ECU 20, a multimedia ECU 30, an advanced driver assistance ECU 40, and a DCM 50. The vehicle 100 also includes a first external bus 61, a second external bus 62, a third external bus 63, and a fourth external bus 64. Note that the term “ECU” is an abbreviation for “electronic control unit.” Also, the term “DCM” is an abbreviation for “data communication module”.

The central ECU 10 centrally controls the overall vehicle 100. The central ECU 10 includes a CPU 11, ROM 12, RAM 13, storage 14, and an internal bus 15. Note that “CPU” is an abbreviation for “central processing unit”. “ROM” is an abbreviation for “read only memory”. “RAM” is an abbreviation for “random access memory”. The internal bus 15 connects the CPU 11, the ROM 12, the RAM 13, and the storage 14, so as to be capable of mutual communication. The ROM 12 stores various types of programs and various types of data in advance. Also, the ROM 12 stores, in advance, an update program 12A, which is executed when updating software, as one of the various types of programs. The RAM 13 is volatile memory. The RAM 13 temporarily stores various types of programs and various types of data. The CPU 11 uses the RAM 13 as a work area to execute various types of processing by reading programs from the ROM 12. Also, the CPU 11 executes various types of processing in a software updating method by reading the update program 12A. In the present embodiment, the central ECU 10 is an example of a software updating device.

The storage 14 is capable of storing various types of programs and various types of data. The storage 14 is nonvolatile memory that is electrically rewritable. For example, the storage 14 is NAND flash memory.

The DCM 50 is connected to the central ECU 10 via the first external bus 61. The DCM 50 is capable of wireless communication with equipment that is external from the vehicle 100 via a communication network NW. Accordingly, the central ECU 10 is capable of wireless communication with equipment that is external from the vehicle 100 via the first external bus 61 and the DCM 50.

The powertrain ECU 20 is capable of mutual communication with the central ECU 10 via the second external bus 62. The powertrain ECU 20 executes various types of processing for controlling an engine, a transmission, and so forth, which are omitted from illustration. The powertrain ECU 20 includes a CPU 21, ROM 22, RAM 23, storage 24, and an internal bus 25. The internal bus 25 connects the CPU 21, the ROM 22, the RAM 23, and the storage 24, so as to be capable of mutual communication. The ROM 22 stores various types of programs and various types of data in advance. Also, the ROM 22 stores a control program 22A, in advance, as one of the various types of programs. The ROM 22 is so-called erasable programmable read-only memory (EPROM). That is to say, the control program 22A stored in the ROM 22 can be updated. The RAM 23 is volatile memory. The RAM 23 temporarily stores various types of programs and various types of data. The CPU 21 uses the RAM 23 as a work area to execute various types of processing by reading programs from the ROM 22. Also, the CPU 21 executes various types of processing for controlling the engine, the transmission, and so forth, by reading the control program 22A. In the present embodiment, the powertrain ECU 20 is an example of an information processing device of which software is updated.

The storage 24 is capable of storing various types of programs and various types of data. The storage 24 is nonvolatile memory that is electrically rewritable. For example, the storage 24 is NOR flash memory.

The multimedia ECU 30 is capable of mutual communication with the central ECU 10 via the third external bus 63. The multimedia ECU 30 controls an automotive navigation system, an audio device, and so forth, which are omitted from illustration. An internal configuration of the multimedia ECU 30 is the same as the internal configuration of the powertrain ECU 20. The advanced driver assistance ECU 40 is capable of mutual communication with the central ECU 10 via the fourth external bus 64. The advanced driver assistance ECU 40 realizes various types of driver assistance by executing various types of applications. Note that the various types of applications include an application for adaptive cruise control, in which a vehicle traveling ahead of the vehicle 100 is followed while maintaining a constant distance thereto, an application for automatically braking the vehicle 100 in order to mitigate damage thereof in a collision, and so forth. An internal configuration of the advanced driver assistance ECU 40 is the same as the internal configuration of the powertrain ECU 20. Note that the vehicle 100 includes various types of ECUs that are omitted from illustration, such as a steering ECU, a brake ECU, a body ECU, and so forth. These various types of ECUs are all capable of communication with the central ECU 10 via a bus.

As illustrated in FIG. 1, the vehicle 100 includes an equipment group made up of a plurality of pieces of equipment. Examples of these pieces of equipment are a secondary battery 71 and a display 76. The secondary battery 71 supplies electric power to the central ECU 10, the powertrain ECU 20, the multimedia ECU 30, the advanced driver assistance ECU 40, the DCM 50, and so forth. Note that in FIG. 1, just an electric power path connecting the secondary battery 71 and the central ECU 10, and an electric power path connecting the secondary battery 71 and the powertrain ECU 20, are representatively illustrated.

The display 76 is capable of displaying various types of information. Also, the display 76 is a so-called touch panel display. Accordingly, the user of the vehicle 100 can input various types of information via the display 76. That is to say, the display 76 functions both as output equipment that outputs information to the user, and as input equipment that accepts information from the user.

The central ECU 10 displays various types of information on the display 76 by outputting control signals to the display 76. Also, the central ECU 10 acquires, from the display 76, information input by the user of the vehicle 100.

As illustrated in FIG. 1, the updating system US includes a data center 200. An example of the data center 200 is a so-called server. The data center 200 includes an executing unit 210, a storage unit 220, and a communication unit 230. The communication unit 230 is capable of communication with equipment that is external from the data center 200 via the communication network NW. The storage unit 220 includes ROM, RAM, and storage. The storage unit 220 stores various types of data. The storage unit 220 also stores various types of programs in advance. The executing unit 210 executes various types of processing by reading the programs in the storage unit 220. Note that an example of the executing unit 210 is a CPU.

The updating system US illustrated in FIG. 1 includes a plurality of personal terminals 300. An example of the personal terminal 300 is a mobile terminal owned by the user of the vehicle 100, a so-called smartphone. Note that in FIG. 1, just one personal terminal 300 is illustrated representatively. The personal terminal 300 includes an executing unit 310, a storage unit 320, and a communication unit 330. The communication unit 330 is capable of communication with equipment that is external from the personal terminal 300 via the communication network NW. The storage unit 320 includes ROM, RAM, and storage. The storage unit 320 stores various types of data. Also, the storage unit 320 stores schedule information IS, as one of the various types of data. Here, the schedule information IS includes information regarding whether a scheduled event is scheduled for the user, information regarding a time slot of the scheduled event, and information regarding a location of the scheduled event. For example, a scheduled event is designated by name and location of the scheduled event, along with a time slot such as from A o'clock to B o'clock on mm/dd/yyyy (month/day/year). Accordingly, in a time slot in which a scheduled event is designated as described above, this indicates that there is a scheduled event in that time slot. In a time slot in which no time slot for any scheduled event is designated, this indicates that there is no scheduled event in that time slot. Note that the scheduled event is stored in the storage unit 320 as schedule information IS by the user performing input thereof by operating the personal terminal 300. Further, the storage unit 320 stores various types of programs in advance. The executing unit 310 executes various types of processing by reading the programs in the storage unit 320. Note that an example of the executing unit 310 is a CPU. In the present embodiment, the personal terminal 300 is an example of a schedule management device.

### (1) First Control

Next, with reference to FIG. 2, first control executed by the central ECU 10 of the vehicle 100 and the data center 200 will be described. This first control is control related to downloading software to be updated. The first control is executed in parallel between each central ECU 10 of the vehicles 100 and one data center 200. In the present embodiment, the data center 200 starts executing the first control every time a request for updating software is made. Note that hereinafter processing for updating the control program 22A will be described as an example of performing updating of software.

As shown in FIG. 2, upon starting the first control, the executing unit 210 of the data center 200 executes the processing of step S11. In step S11, the executing unit 210 of the data center 200 transmits, to the central ECU 10, a campaign notification NC indicating that a request for updating software has been made. Here, the campaign notification NC includes information indicating the type of the software to be updated, information indicating the size of the software to be updated, and so forth. Note that in the example described here, the information indicating the type of the software to be updated is information indicating that the software to be updated is the control program 22A of the powertrain ECU 20. When the CPU 11 of the central ECU 10 receives the campaign notification NC, the CPU 11 of the central ECU 10 advances the processing to step S12.

In step S12, the CPU 11 of the central ECU 10 confirms with the user of the vehicle 100 whether he or she consents to execution of downloading of a new control program 22A in order to update the control program 22A. Specifically, the CPU 11 of the central ECU 10 outputs a control signal to the display 76, causing the display 76 to display options regarding whether to consent to execution of downloading of the control program 22A. When consent is not obtained from the user of the vehicle 100, the CPU 11 of the central ECU 10 then displays, at regular intervals, options of whether to consent to the execution of downloading of the control program 22A. On the other hand, when consent is obtained from the user of the vehicle 100, the CPU 11 of the central ECU 10 advances the processing to step S13.

In step S13, the CPU 11 of the central ECU 10 transmits a request signal to the data center 200 to request transmission of the new control program 22A. When the executing unit 210 of the data center 200 receives the request signal, the executing unit 210 of the data center 200 advances the processing to step S14.

In step S14, the executing unit 210 of the data center 200 transmits the new control program 22A to the central ECU 10. In other words, the CPU 11 of the central ECU 10 downloads the new control program 22A from the data center 200. At this time, the CPU 11 of the central ECU 10 stores the new control program 22A in the storage 14 of the central ECU 10. Following step S14, the CPU 11 of the central ECU 10 ends the first control for this time.

### (2) Second Control

Next, with reference to FIG. 2, second control executed by the central ECU 10 of the vehicle 100 and the personal terminal 300 will be described. This second control is control related to deciding a scheduled update date-and-time TZ of the software to be updated. The second control is executed between the central ECU 10 of the vehicle 100 and the personal terminal 300 of the user of that vehicle 100. Note that the central ECU 10 of the vehicle 100 and the personal terminal 300 of the user of that vehicle 100 are associated in advance. In the present embodiment, the CPU 11 of the central ECU 10 starts execution of the second control on the condition that the first control is completed.

As shown in FIG. 2, upon beginning the second control, the CPU 11 of the central ECU 10 executes the processing of step S31. In step S31, the CPU 11 of the central ECU 10 transmits, to the personal terminal 300, a request signal for requesting transmission of the schedule information IS. When the executing unit 310 of the personal terminal 300 receives the request signal, the executing unit 310 of the personal terminal 300 advances the processing to step S32.

In step S32, the executing unit 310 of the personal terminal 300 transmits the schedule information IS to the central ECU 10. When the CPU 11 of the central ECU 10 receives the schedule information IS, the CPU 11 of the central ECU 10 then stores the schedule information IS in the storage 14 of the central ECU 10. Thus, the processing of step S32 is processing of acquiring the schedule information IS. Following step S32, the CPU 11 of the central ECU 10 advances the processing to step S41.

In step S41, the CPU 11 of the central ECU 10 identifies an unset period TA in which no scheduled event is set, based on the schedule information IS. Specifically, the CPU 11 of the central ECU 10 identifies the unset period TA based on information regarding the time slot of the scheduled event included in the schedule information IS. For example, assumption will be made that the scheduled events of the user included in the schedule information IS include a first scheduled event and a second scheduled event, on a given certain day. Also, assumption will be made that the time slot of the first scheduled event is from 6:00 to 12:00. Further, assumption will be made that the time slot of the second scheduled event is from 18:00 to 24:00. In this case, the CPU 11 of the central ECU 10 identifies time slots excluding the time slot of the first scheduled event and the time slot of the second scheduled event on the certain day, i.e., the time slot from 0:00 to 6:00 and the time slot from 12:00 to 18:00, as unset periods TA on the certain day. Note that the CPU 11 of the central ECU 10 identifies a future time slot following the point in time of processing step S41 as the unset period TA. In the present embodiment, the CPU 11 of the central ECU 10 identifies a plurality of unset periods TA in the way that is described above. Following step S41, the CPU 11 of the central ECU 10 advances the processing to step S42.

In step S42, the CPU 11 of the central ECU 10 predicts a non-use period TB, which is a period during which the user of the vehicle 100 will not use the vehicle 100. The CPU 11 of the central ECU 10 predicts the non-use period TB as follows, for example. First, the CPU 11 of the central ECU 10 acquires usage history of the vehicle 100 by the user of the vehicle 100 for a period from the point in time of processing in step S42 to a before a designated period. An example of the designated period here is seven days. Also, the CPU 11 of the central ECU 10 extracts a time slot in which the vehicle 100 is not used on any day, for a period from the point in time of processing step S42 up to before the designated period, based on the usage history of the vehicle 100 that is acquired. The CPU 11 of the central ECU 10 then predicts the extracted time slot to be a non-use period TB. For example, assumption will be made that the vehicle 100 is used during a time slot from 6:00 to 12:00 on a given first certain day. Also, assumption will be made that the vehicle 100 is used during a time slot from 9:00 to 15:00 on a given second certain day. Further, assumption will be made that the vehicle 100 is used during a time slot from 12:00 to 18:00 on a given third certain day. In this case, the CPU 11 of the central ECU 10 extracts the time slots from 0:00 to 6:00 and from 18:00 to 24:00 as time slots in which the vehicle 100 is not used on any day. The CPU 11 of the central ECU 10 then predicts the time slot from 0:00 to 6:00 and the time slot from 18:00 to 24:00 to be the non-use period TB. Following step S42, the CPU 11 of the central ECU 10 advances the processing to step S43.

In step S43, the CPU 11 of the central ECU 10 predicts a blank period TC in the future, in which no scheduled event will occur, based on the schedule information IS. Specifically, the CPU 11 of the central ECU 10 predicts a period that is within a non-use period TB and is an unset period TA to be a blank period TC. For example, assumption will be made that the non-use period TB is a time slot from 0:00 to 6:00, and a time slot from 18:00 to 24:00. Also, assumption will be made that the unset period TA is a time slot from 0:00 to 6:00, and a time slot from 12:00 to 18:00. In this case, the blank period TC is a time slot from 0:00 to 6:00. Note that the CPU 11 of the central ECU 10 predicts a future time slot following the point in time of the processing of step S43 to be a blank period TC. In the present embodiment, the CPU 11 of the central ECU 10 predicts a plurality of blank periods TC in the way that is described above. Following step S43, the CPU 11 of the central ECU 10 advances the processing to step S44.

In step S44, the CPU 11 of the central ECU 10 decides a scheduled update date-and-time TZ, which is a date and time for performing updating of the control program 22A for the powertrain ECU 20, within the blank period TC. The CPU 11 of the central ECU 10 decides the scheduled update date-and-time TZ as follows, for example. First, the CPU 11 of the central ECU 10 estimates the length of the period necessary to update the control program 22A, based on information indicating the size of the software to be updated, which is included in the campaign notification NC. Also, the CPU 11 of the central ECU 10 extracts a blank period TC of which the length of the blank period TC is longer than the length of the period necessary for updating the control program 22A, from the blank periods TC. Further, the CPU 11 of the central ECU 10 identifies a blank period TC close to the point in time of the processing of step S44, from among the extracted blank periods TC. The CPU 11 of the central ECU 10 then decides the scheduled update date-and-time TZ to be in an intermediate portion of the blank period TC that is identified. For example, assumption will be made that the blank period TC is a time slot from 0:00 to 6:00. Also, assumption will be made that the length of the period required to update the control program 22A is two hours. In this case, the CPU 11 of the central ECU 10 sets the time slot from 2:00 to 4:00 to be the scheduled update date-and-time TZ. Following step S44, the CPU 11 of the central ECU 10 advances the processing to step S51. In other words, upon deciding the scheduled update date-and-time TZ, the CPU 11 of the central ECU 10 advances the processing to step S51.

In step S51, the CPU 11 of the central ECU 10 confirms with the user of the vehicle 100 whether he or she consents to performing updating of the control program 22A at the scheduled update date-and-time TZ. Specifically, the CPU 11 of the central ECU 10 outputs a control signal to the display 76, causing the display 76 to display options regarding whether to consent to performing updating of the control program 22A at the scheduled update date-and-time TZ. When consent is not obtained from the user of the vehicle 100, the CPU 11 of the central ECU 10 then displays, at regular intervals, options of whether to consent to performing updating of the control program 22A at the scheduled update date-and-time TZ. On the other hand, when consent is obtained from the user of the vehicle 100, the CPU 11 of the central ECU 10 advances the processing to step S52. In other words, the CPU 11 of the central ECU 10 advances the processing to step S52 on the condition that consent has been obtained for performing updating of the control program 22A at the scheduled update date-and-time TZ.

In step S52, the CPU 11 of the central ECU 10 transmits an addition notification NA to the personal terminal 300 requesting addition of a scheduled event for performing updating of the control program 22A at the scheduled update date-and-time TZ. The addition notification NA includes information regarding the scheduled update date-and-time TZ. Note that the processing in step S52 is processing in which the central ECU 10 externally transmits information regarding the scheduled update date-and-time TZ. Further, the processing in step S52 is processing in which the personal terminal 300 acquires the information regarding the scheduled update date-and-time TZ from the central ECU 10. When the executing unit 310 of the personal terminal 300 receives the addition notification NA, the executing unit 310 of the personal terminal 300 advances the processing to step S53.

In step S53, the executing unit 310 of the personal terminal 300 updates the schedule information IS based on the addition notification NA. Specifically, the CPU 11 of the central ECU 10 adds a scheduled event for performing updating of the control program 22A at the scheduled update date-and-time TZ to the schedule information IS based on the addition notification NA. Following step S53, the executing unit 310 of the personal terminal 300 ends the second control for this time.

### Third Control

Next, third control executed by the central ECU 10 of the vehicle 100 will be described with reference to FIG. 2. This third control is control related to enabling the software to be updated. In the present embodiment, the CPU 11 of the central ECU 10 starts executing the third control on the condition that the second control is completed and the system of the vehicle 100 is in an off state. Note that the system of the vehicle 100 being in an off state refers to a state in which no electric power is supplied to any of the ECUs, excluding the central ECU 10. Accordingly, the system of vehicle 100 is in the on state when the vehicle 100 is in a traveling state, and each piece of equipment of the vehicle 100 is in an accessory-on state in which the equipment can be used.

As shown in FIG. 2, upon beginning the third control, the CPU 11 of the central ECU 10 executes the processing of step S71. In step S71, the CPU 11 of the central ECU 10 determines whether the point in time of the processing of step S71 is within the scheduled update date-and-time TZ. In step S71, when the CPU 11 of the central ECU 10 determines that the point in time of the processing of step S71 is not within the scheduled update date-and-time TZ, the CPU 11 of the central ECU 10 advances the processing to step S71 again. On the other hand, in step S71, when the CPU 11 of the central ECU 10 determines that the point in time of the processing of step S71 is within the scheduled update date-and-time TZ, the CPU 11 of the central ECU 10 advances the processing to step S72.

In step S72, the CPU 11 of the central ECU 10 executes updating of the control program 22A stored in the ROM 22 of the powertrain ECU 20. Specifically, the CPU 11 of the central ECU 10 turns the powertrain ECU 20 to an on state. Further, the CPU 11 of the central ECU 10 installs the new control program 22A that is stored in the storage 14 to the ROM 22 of the powertrain ECU 20. The CPU 11 of the central ECU 10 then activates the control program 22A that is installed. Thereafter, the CPU 11 of the central ECU 10 turns the powertrain ECU 20 to an off state. Following step S72, the CPU 11 of the central ECU 10 ends the third control for this time.

### Operations of Present Embodiment

Assumption will be made that a request to update the control program 22A stored in the powertrain ECU 20 of the vehicle 100 is made, for example. In this case, as shown in FIG. 2, the central ECU 10 of the vehicle 100 and the data center 200 execute the first control, that is, the processing of steps S11 to S14. As a result, the CPU 11 of the central ECU 10 downloads the new control program 22A from the data center 200. Further, when the first control ends, the central ECU 10 of the vehicle 100 and the personal terminal 300 execute the second control, that is, the processing of steps S31 to S53. In step S32, the CPU 11 of the central ECU 10 then acquires the schedule information IS from the personal terminal 300. Also, in step S41 to step S43, the CPU 11 of the central ECU 10 predicts a blank period TC in the future in which no scheduled event will occur, based on the schedule information IS. Further, in step S44, the CPU 11 of the central ECU 10 decides a scheduled update date-and-time TZ, which is a date and time for performing updating of the control program 22A for the powertrain ECU 20, within the blank period TC. Also, when the second control ends, the central ECU 10 of the vehicle 100 executes the third control, i.e., the processing of steps S71 and S72. As a result, when the scheduled update date-and-time TZ arrives, the CPU 11 of the central ECU 10 executes updating of the control program 22A stored in the ROM 22 of the powertrain ECU 20. Specifically, the CPU 11 of the central ECU 10 executes installation and activation of the new control program 22A at the scheduled update date-and-time TZ.

### Effects of Present Embodiment

(1) According to the present embodiment, the scheduled update date-and-time TZ is decided within the blank period TC during which a scheduled event is unlikely to occur for the user of the vehicle 100. This can suppress the control program 22A from being updated at a time that is inconvenient for the user of the vehicle 100.
(2) In step S52 of the second control, the CPU 11 of the central ECU 10 transmits an addition notification NA including information regarding the scheduled update date-and-time TZ to the personal terminal 300. Thus, the user of the vehicle 100 can comprehend the scheduled update date-and-time TZ for executing the update of the control program 22A, for example, by checking the information regarding the scheduled update date-and-time TZ transmitted to the personal terminal 300.
(3) In step S52 of the second control, the personal terminal 300 acquires the addition notification NA from the central ECU 10 of the vehicle 100 requesting addition of a scheduled event for performing updating of the control program 22A at the scheduled update date-and-time TZ. In step S53, the executing unit 310 of the personal terminal 300 then updates the schedule information IS based on the addition notification NA. Specifically, the CPU 11 of the central ECU 10 adds a scheduled event for performing updating of the control program 22A at the scheduled update date-and-time TZ to the schedule information IS based on the addition notification NA. Thus, the user of the vehicle 100 can comprehensively manage the scheduled event of performing updating of the control program 22A at the scheduled update date-and-time TZ, along with other scheduled events.
(4) In step S41 of the second control, the CPU 11 of the central ECU 10 identifies an unset period TA in which no scheduled event is set, based on the schedule information IS. Also, in step S42, the CPU 11 of the central ECU 10 predicts a non-use period TB, which is a period during which the user of the vehicle 100 will not use the vehicle 100. Then, in step S43, the CPU 11 of the central ECU 10 predicts a period that is within the non-use period TB and is an unset period TA as a blank period TC in which no scheduled event will occur in the future. In other words, the CPU 11 of the central ECU 10 takes into account not only unset periods TA in which no scheduled event is set in the schedule information IS, but also non-use periods TB, which are periods in which the user of the vehicle 100 does not use the vehicle 100, and predicts the blank period TC accordingly. By taking the non-use periods TB into account in this way, a situation in which a period in which the user of the vehicle 100 wants to use the vehicle 100 clashes with the blank period TC, for example, can be suppressed. As a result, a situation can be suppressed in which the vehicle 100 is unavailable due to updating of the control program 22A.
(5) In step S51 of the second control, the CPU 11 of the central ECU 10 confirms with the user of the vehicle 100 whether he or she consents to performing updating of the control program 22A at the scheduled update date-and-time TZ. The CPU 11 of the central ECU 10 then advances the processing to step S52 and thereafter on the condition that consent has been obtained for performing updating of the control program 22A at the scheduled update date-and-time TZ. In other words, the CPU 11 of the central ECU 10 executes the updating of the control program 22A at the scheduled update date-and-time TZ in the third control, on the condition that consent is obtained for performing updating of the control program 22A at the scheduled update date-and-time TZ. Thus, the control program 22A can be more reliably suppressed from being updated at a time that is inconvenient for the user of the vehicle 100.
(6) In general, ROM devices can be roughly divided into single-bank ROM devices having one data storage regions and double-bank ROM devices having two data storage regions. With single-bank ROM, when executing updating of software, the single-bank ROM needs to be placed in an off state before installation and activation of the software are executed. With double-bank ROM on the other hand, even when the double-bank ROM is in an on state, software can be installed in a storage region that is different from the data storage area used in the on state. However, even with double-bank ROM, the double-bank ROM needs to be placed in an off state before executing activation of the software.

With respect to this point, in step S72 of the third control, the CPU 11 of the central ECU 10 executes installation and activation of the new control program 22A at the scheduled update date-and-time TZ. That is to say, the update of the control program 22A in step S72 includes activation. Thus, even when the ROM 22 in which the control program 22A is to be updated is double-bank ROM, the ROM 22 cannot be used during the period in which updating of the control program 22A is being executed in step S72. Accordingly, it is particularly effective to execute updating of the control program 22A in step S72 at the scheduled update date-and-time TZ decided within the blank period TC.

### Modifications

The present embodiment can be carried out modified as follows. The present embodiment and the following modifications can be carried out combined with each other as long as no technical contradiction arises.
In the above embodiment, the first control may be changed.
   For example, the processing of step S12 may be omitted. As a specific example, when the CPU 11 of the central ECU 10 receives a campaign notification NC in step S11, the CPU 11 of the central ECU 10 may advance the processing to step S13. Note that even when the processing of step S12 is omitted, the effects will be slight as long as the CPU 11 of the central ECU 10 makes confirmation in step S51 regarding whether consenting to perform updating of the control program 22A at the scheduled update date-and-time TZ.
In the above embodiment, the second control may be changed.
   For example, the way of predicting the non-use period TB in step S42 may be changed. As a specific example, the CPU 11 of the central ECU 10 may predict, as the non-use period TB, a time slot in which the vehicle 100 is not used on any day, with a margin included therein. As an example, assumption will be made that, regarding the period from the point in time of processing step S42 to before the designated period, the time slot during which the vehicle 100 is not used on any day is a time slot from 0:00 to 6:00. In this case, the CPU 11 of the central ECU 10 may predict a time slot in which the vehicle 100 is not used on any day, with a margin included therein, such as a time slot from 1:00 to 5:00 for example, as the non-use period TB.

As a specific example, the CPU 11 of the central ECU 10 may predict the non-use period TB based on information regarding the time slot of the scheduled event and information regarding the location of the scheduled event, which are included in the schedule information IS. For example, assumption will be made that the scheduled events of the user included in the schedule information IS include a first scheduled event and a second scheduled event, on a given certain day. Also, assumption will be made that the time slot of the first scheduled event is from 6:00 to 12:00. Further, assumption will be made that the time slot of the second scheduled event is from 18:00 to 24:00. Based on a distance from the location of the first scheduled event to the location of the second scheduled event, and a length of the time slot between the first scheduled event and the second scheduled event, the CPU 11 of the central ECU 10 determines whether it is likely that the user will use the vehicle 100 during that time slot. For example, the CPU 11 estimates that it is likely that the user will use the vehicle 100, when a value obtained by dividing the distance from the location of the first scheduled event to the location of the second scheduled event by the length of the time slot between the first scheduled event and the second scheduled event is no greater than a designated value set in advance. In other words, when the distance from the location of the first scheduled event to the location of the second scheduled event is relatively short with respect to the length of the time slot between the first scheduled event and the second scheduled event, the CPU 11 estimates that it is likely that the user will use the vehicle 100. When estimating that it is likely that the user will use the vehicle 100 in the time slot between the first scheduled event and the second scheduled event, the CPU 11 predicts the time slot excluding that time slot to be a non-use period TB.
For example, the way of predicting the blank period TC in step S43 may be changed. As a specific example, the CPU 11 of the central ECU 10 may predict the unset period TA to be the blank period TC. In this case, the processing of step S42 can be omitted. Also, as a specific example, the CPU 11 of the central ECU 10 may predict, as the blank period TC, a time slot in which a margin is included in the unset period TA. As an example, assumption will be made that the unset period TA is a time slot from 0:00 to 6:00. In this case, the CPU 11 of the central ECU 10 may predict, as the blank period TC, a time slot in which a margin is included in the unset period TA, such as a time slot from 1:00 to 5:00, for example.
For example, the way of deciding the scheduled update date-and-time TZ in step S44 may be changed. As a specific example, the CPU 11 of the central ECU 10 may decide the scheduled update date-and-time TZ to be in the first half of the blank period TC, or decide to be in the second half of the blank period TC, when within the blank period TC.
For example, the way of confirming consent in step S51 may be changed. As a specific example, the CPU 11 of the central ECU 10 may output a control signal to the personal terminal 300, so that the personal terminal 300 displays an option of whether to consent to perform updating of the control program 22A at the scheduled update date-and-time TZ.
For example, the processing of step S51 may be omitted. Note that even when the processing of step S51 is omitted, the effects will be slight because the CPU 11 of the central ECU 10 decides the scheduled update date-and-time TZ within the blank period TC.
For example, the contents of processing in step S52 and step S53 may be changed. As a specific example, in step S52, the CPU 11 of the central ECU 10 may transmit just information regarding the scheduled update date-and-time TZ to the personal terminal 300, instead of the addition notification NA. In this case, the executing unit 310 of the personal terminal 300 does not need to update the schedule information IS in step S53. Note that the executing unit 310 of the personal terminal 300 preferably performs annunciation to the user of the personal terminal 300, on the display of the personal terminal 300 or the like, that updating of the control program 22A will be performed at the scheduled update date-and-time TZ, based on the information regarding the scheduled update date-and-time TZ.
For example, the processing of step S52 and step S53 may be omitted. Note that even when the processing of step S52 and step S53 is omitted, the effects will be slight because the CPU 11 of the central ECU 10 decides the scheduled update date-and-time TZ within the blank period TC.
In the above embodiment, the third control may be changed.
For example, the processing contents of step S72 may be changed. As a specific example, in step S72, the CPU 11 of the central ECU 10 may execute downloading, installation, and activation of the new control program 22A at the scheduled update date-and-time TZ. In this case, the processing of step S13 and step S14 can be omitted in the first control.

Also, as a specific example, in step S72, the CPU 11 of the central ECU 10 may execute just activation, out of the downloading, installation, and activation of the new control program 22A, at the scheduled update date-and-time TZ. In this case, in step S14, the CPU 11 of the central ECU 10 can execute downloading and installation of the new control program 22A.
In the above embodiment, the configuration of the updating system US may be changed.
   For example, the software updating device is not limited to the central ECU 10. As a specific example, a CPU of the multimedia ECU 30 may execute the first control, the second control, and the third control, by reading the update program 12A stored in ROM of the multimedia ECU 30, instead of the central ECU 10. That is to say, the software updating device is not limited to the central ECU 10, and other ECUs installed in the vehicle 100 can be employed.

Also, as a specific example, a personal terminal of a user of the vehicle 100, a server that is external from the vehicle 100, or the like, can be employed instead of the central ECU 10. That is to say, the software updating device is not limited to the central ECU 10, and other devices not installed in the vehicle 100 can be employed.
For example, the schedule management device is not limited to the personal terminal 300. As a specific example, a so-called server or the like may store the schedule information IS, instead of the personal terminal 300. In this case, the CPU 11 of the central ECU 10 can acquire the schedule information IS stored in the above server or the like.

### Other Technical Ideas

Technical ideas that can be comprehended from the above embodiment and modifications will be described.

A software updating device according to an aspect of the present disclosure includes a CPU being configured to execute: obtaining schedule information, the schedule information including information regarding whether a scheduled event is scheduled for a user and information regarding a time slot of the scheduled event; predicting a blank period in the future in which the scheduled event will not occur, based on the schedule information that is acquired; deciding a scheduled update date-and-time that is a date and time when an update of software for an information processing device is performed, within the blank period; and performing the update of the software at the scheduled update date-and-time.

In the above aspect, the CPU may be configured to execute external transmission of information regarding the scheduled update date-and-time when the scheduled update date-and-time is decided.

In the above aspect, the CPU may be configured to execute performing, when the scheduled update date-and-time is decided, confirmation regarding whether the user consents to perform the update of the software at the scheduled update date-and-time, and performing the update of the software at the scheduled update date-and-time, on a condition that consent to performing the update of the software at the scheduled update date-and-time is obtained.

In the above aspect, the update of the software may include activating an updated version of the software.

In the above aspect, the information processing device may be installed in a vehicle. The CPU may be configured to execute predicting a non-use period that is a period during which the user will not use the vehicle, and predicting a period within the non-use period in which the scheduled event will not occur for the user, as the blank period.

What is claimed is:

1. A software updating device comprising a central processing unit (CPU), the CPU being configured to execute:
obtaining schedule information, the schedule information including information regarding whether a scheduled event is scheduled for a user and information regarding a time slot of the scheduled event;
predicting a blank period in the future in which the scheduled event will not occur, based on the schedule information that is acquired;
deciding a scheduled update date-and-time that is a date and time when an update of software for an information processing device is performed, within the blank period; and
performing the update of the software at the scheduled update date-and-time.

2. The software updating device according to claim 1, wherein the CPU is configured to execute external transmission of information regarding the scheduled update date-and-time when the scheduled update date-and-time is decided.

3. The software updating device according to claim 1, wherein the CPU is configured to execute
performing, when the scheduled update date-and-time is decided, confirmation regarding whether the user consents to perform the update of the software at the scheduled update date-and-time, and
performing the update of the software at the scheduled update date-and-time, on a condition that consent to performing the update of the software at the scheduled update date-and-time is obtained.

4. The software updating device according to claim 1, wherein the update of the software includes activating an updated version of the software.

5. The software updating device according to claim 1, wherein:
the information processing device is installed in a vehicle; and
the CPU is configured to execute
predicting a non-use period that is a period during which the user will not use the vehicle, and
predicting a period within the non-use period in which the scheduled event will not occur for the user, as the blank period.

6. A software updating method executed by an updating device, the software updating method comprising:
obtaining schedule information, the schedule information including information regarding whether a scheduled event is scheduled for a user and information regarding a time slot of the scheduled event;
predicting a blank period in the future in which the scheduled event will not occur, based on the schedule information that is acquired;
deciding a scheduled update date-and-time that is a date and time when an update of software for an information processing device is performed, within the blank period; and
performing the update of the software at the scheduled update date-and-time.

7. A non-transitory storage medium storing instructions that are executable by an updating device and that cause the updating device to execute the software updating method according to claim 6.

8. A software updating system, comprising:
a schedule management device that stores schedule information, the schedule information including information regarding whether a scheduled event is scheduled for a user and information regarding a time slot of the scheduled event; and
an updating device that is configured to communicate with the schedule management device, and that is installed in a vehicle, wherein:
the updating device is configured to execute
acquiring the schedule information from the schedule management device,
predicting a blank period in the future in which the scheduled event will not occur, based on the schedule information that is acquired,
deciding a scheduled update date-and-time that is a date and time when an update of software for an information processing device installed in the vehicle is performed, within the blank period,
transmitting information regarding the scheduled update date-and-time to the schedule management device when the scheduled update date-and-time is decided, and
performing the update of the software at the scheduled update date-and-time; and
the schedule management device is configured to execute
acquiring information regarding the scheduled update date-and-time from the updating device, and
updating the schedule information in accordance with information regarding the scheduled update date-and-time.
